(19) United States
(12) Patent Application Publication
(10) Pub. No.: US 2026/0368347 A1
(43) Pub. Date: Nov. 19, 2026

(54) PRIVACY-PRESERVING LIFECYCLE TRACKING FOR COMPUTING DEVICES

(71) Applicant: Google LLC, Mountain View, CA (US)

(72) Inventors: Da Won Lee, Jersey City, NJ (US); Hirthanan Subenderan, Milpitas, CA (US); Qian Wang, San Jose, CA (US); Narendra K. Singhal, Cupertino, CA (US); Kevin Wei Li Yeo, New York, NY (US); Aaron Segal, Dobbs Ferry, NY (US); Shreyas Karkhedkar, Mountain View, CA (US); Gregory M. Levin, Santa Clara, CA (US)

(21) Appl. No.: 19/207,131

(22) Filed: May 13, 2025

(51) Int. Cl. G06F 21/62

(52) U.S. Cl. CPC G06F 21/6227

(57) ABSTRACT

A system and method for privacy-preserving lifecycle tracking of computing devices. The method includes receiving surrogate identifiers from a first set of devices. Each surrogate identifier comprises an activity status of a respective device of the first set of devices for a first time-window. Further, determining a first number of active devices for the first time-window from the first set of surrogate identifiers. Further, receiving a second set of surrogate identifiers from a second set of devices for a second time-window. Further, determining a second number of active devices for the second time-window from the second set of surrogate identifiers. Further determining, based on the first number and the second number, a device lifecycle metric characterizing the plurality of devices.

### TECHNICAL FIELD

Aspects and implementations of the present disclosure relate to privacy-preserving lifecycle tracking for computing devices.

### BACKGROUND

Device manufacturers might need to determine how many devices to produce. This determination may be made based on factors such as sales forecasts for the devices, current device use, or the like.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method including: receiving a first set of surrogate identifiers from a first set of devices of a plurality of devices, wherein each surrogate identifier comprises an activity status of a respective device of the first set of devices for a first time-window; determining a first number of active devices for the first time-window from the first set of surrogate identifiers; receiving a second set of surrogate identifiers from a second set of devices of the plurality of devices, wherein each surrogate identifier comprises metadata indicating an activity status of a respective device of the second set of devices for a second time-window; determining, based on the first set of surrogate identifiers and the second set of surrogate identifiers, that the respective device of the second set of devices is included in the first set of devices; determining a second number of active devices for the second time-window from the second set of surrogate identifiers; and determining, based on the first number and the second number, a device lifecycle metric characterizing the plurality of devices.

In some aspects, the method further includes: sending a cohort identifier to the plurality of devices, wherein each surrogate identifier of the first plurality of surrogate identifiers and each surrogate identifier of the second plurality of surrogate identifiers are generated based on the cohort identifier.

In some aspects, the method further includes maintaining a data structure comprising a plurality of data items, wherein each data item includes: a device identifier, and device metadata associated with the device identifier; receiving an encrypted query from the respective device at the data structure, wherein the encrypted query inquires whether the data structure comprises a respective device identifier for the respective device; and responsive to determining that the data structure comprises the respective device identifier, permitting the respective device to access respective device metadata associated with the respective device identifier.

In some aspects, the method further includes: responsive to determining that the data structure does not comprise a respective device identifier, receiving, from the device, the respective device identifier; generating a data item comprising the respective device identifier of the respective device and the respective device metadata; and adding the data item to the data structure.

In some aspects, device metadata associated with the device identifier includes one or more device activity statuses corresponding to one or more respective reporting period for the respective device having the respective device identifier.

In some aspects, the method further includes: receiving a third set of surrogate identifiers from a third set of devices of the plurality of devices, wherein each surrogate identifier comprises metadata indicating an activity status of a respective device of the third set of devices for a third time-window; determining, based on the third set of surrogate identifiers and at least one of: the first set of surrogate identifiers or the second set of surrogate identifiers, that the respective device of the third set of devices is included in the first set of devices and the second set of devices; determining a third number of active devices for the third time-window from the third plurality of surrogate identifiers; and determining, based on the first number and the third number, a third device lifecycle metric.

In some aspects, the method further includes: determining, based on the second lifecycle metric and the third lifecycle metric, a rolling average lifecycle metric.

In some aspects, determining that the respective device of the second set of devices is included in the first set of devices includes: determining whether an observation window aggregation spanning the first time-window and the second time-window includes the respective device of the second set of devices.

An aspect of the disclosure provides a system including memory and one or more processing devices communicatively coupled to the memory, the one or more processing devices to perform at least a portion of the computer-implemented method described above.

An aspect of the disclosure provides a computer-readable non-transitory storage medium communicatively coupled with a server, the server to perform at least a portion of the computer-implemented method described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, according to aspects of the disclosure.

FIG. 2 is an example block diagram illustrating a relationship between reporting periods, observation windows, and device cohorts, according to some aspects of the present disclosure.

FIG. 3 is an example block diagram illustrating activity history saved for a device in a private set membership (PSM) module, according to some aspects of the disclosure.

FIG. 4 is an example block diagram illustrating how data is ingested into an analytics platform and used by a lifecycle module, according to some aspects of the disclosure.

FIG. 5 is a block diagram illustrating a communication flow between devices and a server, according to some aspects of the disclosure.

FIG. 6 is a flow diagram of an example method for privacy-preserving lifecycle tracking of computing devices, according to some aspects of the disclosure.

FIG. 7 is a flow diagram of an example method for privacy-preserving lifecycle tracking of computing devices, according to some aspects of the disclosure.

FIG. 8 is a flow diagram of an example method for privacy-preserving lifecycle tracking of computing devices, according to some aspects of the disclosure.

FIG. 9 is a block diagram illustrating an example of a computer system, according to aspects of the disclosure.

### DETAILED DESCRIPTION

Aspects of the present disclosure relate to privacy-preserving lifecycle tracking for computing devices. Device manufacturers might need to determine how many new devices to produce. The number of devices to produce may be determined from usage metrics collected from currently deployed devices, such as how often the devices are used, how often the devices are reset, how often the devices fail, how often new devices are activated, and/or how often the devices are replaced. Usage metrics may be used to assess device performance, estimate product longevity, and identify potential shifts in market conditions. Although these usage metrics are critical for data-driven decision-making, accurately determining these metrics presents technical challenges, particularly in contexts requiring preservation of user privacy.

One approach to collecting device usage metrics involves assigning each device a stable and unique identifier that is transmitted to a centralized server during periods of device activity. The server then aggregates and analyzes these unique identifiers to determine which devices were active during an initial time interval but are no longer observed during a subsequent time interval. This allows for precise tracking of device activation events, usage frequency, and the point at which a device becomes inactive. However, this type of reporting actually tracks user metrics in addition to device metrics, which may be undesirable. Additionally, the number of times that a user uses the device to connect to the Internet over the course of a day (for example) is unlikely to be relevant when determining how often the device is replaced.

Aspects of the present disclosure address this and other challenges by implementing privacy-preserving lifecycle tracking for computing devices. Each device reports to an analytics platform once during each reporting period. As used herein, “reporting period” refers to a duration of time defined by an analytics platform for which a device lifecycle metric is collected for a device. A reporting period may have a duration of one or more hours, days, weeks, months, etc., as defined by the analytics platform for the device or set of devices that are to be tracked. When a device reports to the analytics platform, the device reports a surrogate identifier (e.g., a pseudo-anonymous identifier) to the analytics platform. The device may generate the surrogate identifier as a pseudo-random identifier. The surrogate identifier acts as a tally for the device that is being tracked, and may correspond to a certain class, device type, device use-case (e.g., education, enterprise, personal, etc.). By using a surrogate identifier, the analytics platform is unable to track the usage patterns of a particular user of the device. Each time that a device sends a surrogate identifier to the analytics platform in a reporting period, the device updates a locally-stored activity history. Thus, the activity history includes a representation of each reporting period, and an indication of whether the device sent a surrogate identifier for the respective reporting period.

However, when a device is factory-reset, the surrogate identifier and activity history are erased, and a new surrogate identifier is generated. Thus, if a device is factory-reset during a reporting period for which the device has already sent a surrogate identifier, the device will check the activity history (which is empty), determine that a surrogate identifier has not been sent for this reporting period, and send the newly generated surrogate identifier to the analytics platform. Since this is a new surrogate identifier, the analytics platform will not recognize that this device has now sent two surrogate identifiers for this reporting period, and thus the device will be double counted, which may impact the validity of any metrics calculated by the analytics platform (e.g., the device may be counted twice).

To solve this issue, a private set membership (PSM) module may be used to track an activation status of devices. Devices may include executable code that prompt the device to report an activity status to the analytics platform. Prior to sending the surrogate identifier, the device may check the locally stored activity history. If the locally stored activity history is empty, then either (i) the device has not yet been activated, or (ii) the device has been factory-reset. Upon determining that there is no locally stored activity history for the device, the device may send a request to the PSM module. The PSM module may track a set membership for devices. If the device is part of a tracked set, (e.g., has been activated), the PSM module may send an acknowledgement to the device that it is part of the tracked set. As will be further described below, the PSM module is enabled to do this without identifying which device has requested a membership status check. Thus, the device may receive an indication from the PSM module of whether the device has previously been activated. If the device has previously been activated, the PSM module may send an indication of whether the device has sent a surrogate identifier for a requested reporting period (e.g., the current reporting period). If the device has not previously been activated, then the PSM module may request a unique identifier (e.g., a hardware identifier) from the device. The device may provide this unique identifier once to the PSM module, which may then be used indefinitely to track set membership. That is, once the unique identifier has been sent once, set membership of the device may be tracked indefinitely without the device sending the unique identifier to the PSM module again.

Advantages of privacy-preserving lifecycle tracking for computing devices include improved supply-chain and production management, improved manufacturing efficiency and production timelines, improved collection of device performance metrics and estimate of product longevity, and/or an improved ability to identify trends such as potential shifts in market conditions, device failure and/or replacement rates or the like, while preserving the privacy of the users who use these computing devices.

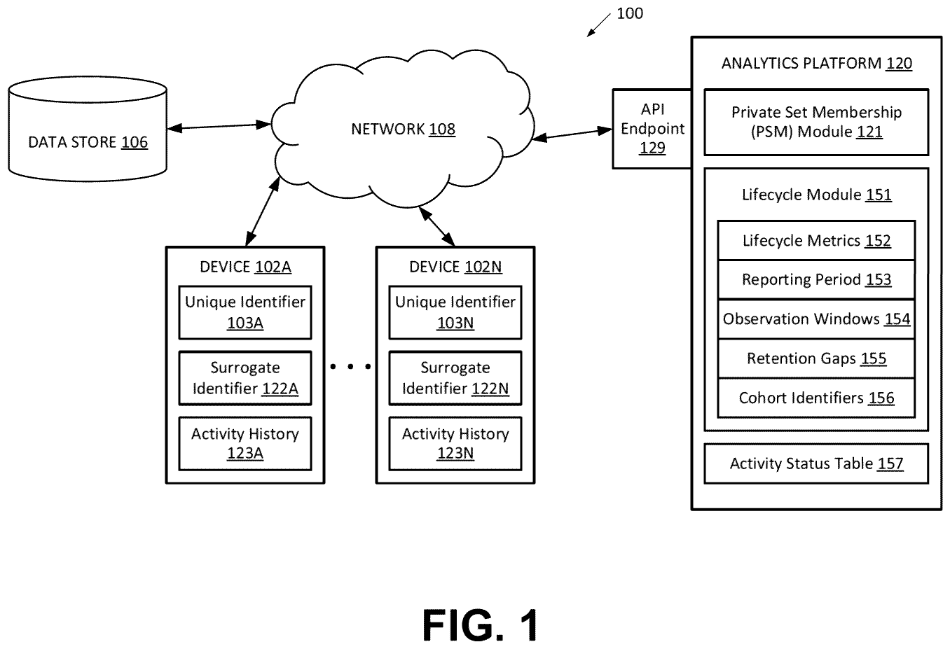

FIG. 1 illustrates an example of system 100, according to some aspects of the disclosure. The system 100 includes devices 102A through devices 102N, a data store 106, and an analytics platform 120, each connected to a network 108.

In implementations, network 108 may include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data store 106 is a persistent storage that is capable of storing data as well as data structures to tag, organize, and index the data. In some implementations, data may include one or more of structured data, unstructured data, vectorized data, etc., or types of digital files, including text data, audio data, image data, video data, multimedia, interactive media, data objects, and/or any suitable type of digital resource, among other types of data. An example of data stored at the data store 106 may include a file, database record, database entry, programming code or document, among others. The data store 106 may be hosted by one or more storage devices, such as main memory, magnetic or optical storage-based disks, tapes or hard drives, network-attached storage (NAS), storage area network (SAN), and so forth. In some implementations, the data store 106 may be a network-attached file server, while in other implementations the data store 106 may be another type of persistent storage such as an object-oriented database, a relational database, and so forth, that may be hosted by analytics platform 120, or one or more different machines coupled to the server hosting the analytics platform 120 via the network 108.

The analytics platform 120 may enable usage tracking of devices 102A-102N. In some implementations, the analytics platform 120 may be used by an organization that provides goods and/or services to consumers, enterprises, government, non-profit organizations, or the like. For example, and in some implementations, the analytics platform 120 may be used by a manufacturer of the devices 102A-102N to determine usage metrics of the devices 102A-102N.

The analytics platform 120 may include a private set membership (PSM) module 121, a lifecycle module 151, and an activity status table 157.

The devices 102A-102N may maintain a local copy of a reporting history that indicates whether the computing has reported its activity status to a lifecycle module 151 for each reporting period 153 using a surrogate identifier 122A, surrogate identifier 122N, etc. The devices 102A-102N may include executable code that may prompt the devices 102A-102N to report its activity status to an lifecycle module 151 multiple times per reporting period 153. If the locally stored activity history 123A, activity history 123N, etc. indicates that the devices 102A-102N have already reported its activity status in the current reporting period 153, the devices 102A-102N does not need to report an activity status to the lifecycle module 151. If the locally stored activity history 123A-123N does not indicate that the devices 102A-102N have reported an activity status for this reporting period 153, the devices 102A-102N may query a private set module (PSM module 121) for its activity history 123A-123N. If the PSM module 121 does not have the activity history 123A-123N for the devices 102A-102N, then the devices 102A-102N has not yet been activated, and thus devices 102A-102N may send its unique hardware identifier to the PSM module 121, which may be added to the private set of tracked devices.

Once the activity history 123A-123N has been determined (whether obtained from the PSM module 121, or obtained as a locally stored activity history 123A-123N), the devices 102A-102N may generate a surrogate identifier 122A-122N based on its private secret value (e.g., a unique hardware identifier) and the activity history 123A-123N. The devices 102A-102N may then send the surrogate identifier 122A-122N to the lifecycle module 151.

Thus, the information sent to the lifecycle module 151 will not contain information that directly identifies the reporting devices 102A-102N. The PSM module 121 module may track an activation status of the devices 102A-102N through factory-resets. This allows the devices 102A-102N to send a single surrogate identifier 122A-122N to the lifecycle module 151, even if the devices 102A-102N receives a factory reset during a reporting period 153. The lifecycle module 151 thus does not receive identifying information for the devices 102A-102N, but may use the surrogate identifier 122A-122N of multiple devices in aggregate to calculate lifecycle metrics for the devices.

The lifecycle module 151 may aggregate multiple-received anonymous identifiers for multiple devices. In some implementations, the multiple surrogate identifiers 122A-122N indicate a first-reporting period 153 for the devices. For example, a surrogate identifier 122A-122N may indicate that January 2021 was a first reporting period 153 for the devices 102A-102N, and that the current reporting period 153 is April 2025. Thus, the lifecycle module 151 may determine, based on the aggregated anonymous identifiers, a lifecycle metric 152 for reporting devices in a particular reporting period 153.

The PSM module 121 may store surrogate identifiers 122A-122N for devices 102A-102N, and a history of activity data for the devices 102A-102N. In some implementations, the surrogate identifiers 122A-122N correspond to persistent hardware identifiers for the devices 102A-102N that do not change when software on the devices 102A-102N changes (e.g., is reset) and a given activity period. In some implementations, the history of activity data for the devices 102A-102N may be an indication, for each reporting period, of device activity.

A reporting period, as used herein, refers to a time interval for which a device activity is to be reported to the analytics platform 120. In some implementations, the reporting period may be one or more hours, days, weeks, months, or the like. Thus, in an illustrative example, for the device 102A, the PSM module 121 may store the unique hardware identifier: “A,” and a historical record indicating which of the past 18 months the device 102A was active. As used herein, a device may be determined to be “active” if it has been powered on. The activity history may reflect whether the device (e.g., devices 102A-102N) reported an active status to the analytics platform 120.

In some implementations, the devices 102A-102N may generate a surrogate identifier based on a persistent hardware identifier for the device 102A-102N and a reporting period. The device 102A-102N may check locally stored activity history on the device to determine if a surrogate identifier has been sent for the current reporting period. For example, the device 102A-102N may check locally stored activity history to determine whether a surrogate identifier was sent for the reporting period of April 2025. In some implementations, the devices 102A-102N do not store a local activity history. In some implementations, if there is no locally stored activity history for the reporting period, then the device 102A-102N may send the surrogate identifier to the PSM module 121. The PSM module 121 may determine whether the same surrogate identifier value has previously been sent (e.g., added to a private set), and is enabled to send a hash back to the device 102A-102N. Upon decrypting the hash, the device 102A-102N may determine whether the device 102A-102N is part of the private set managed by the PSM module 121, which would indicate that a surrogate identifier had previously been sent to the lifecycle module 151. In some implementations, upon decrypting the hash, and determining that the device 102A-102N is a part of the private set managed by the PSM module 121, the device 102A-102N may generate and send one or more surrogate identifiers corresponding to previous reporting period to the PSM module 121 in order to ascertain an activity history. Upon receiving responses to each sent surrogate identifier, the device 102A-102N may generate and store a local activity history to the device 102A-102N.

In some implementations, upon determining that the hash received from the PSM module 121 indicates that the device 102A-102N is not a part of the private set, the device 102A-102N may send the surrogate identifier to the lifecycle module 151. In some implementations, the device 102A-102N is not a part of the private set because it has not reported for the current reporting period, although it may have reported for previous reporting periods. In some implementations, the device 102A-102N is not a part of the private set because it has been activated for the first time during the current reporting period. In some implementations, the device 102A-102N is not a part of the private set because it has not been used for a duration longer than a look-back window of activity history for the device 102A-102N.

Each device 102A-102N may store an activity status for each reporting period that is tracked by the analytics platform 120 (e.g., the history of activity data). As described above, a device may be considered “active” if it has been powered on. In some implementations, the analytics platform 120 may add additional conditions to the activity status, such as a certain duration that the device was powered on, use of a certain application on the device, or the like.

The devices 102A-102N may include executable code that causes the devices 102A-102N to report an active status to the analytics platform at a certain frequency interval. In some implementations, the reporting frequency interval is more often than the reporting period. For example, if the reporting period is one month, the frequency interval may be weekly. To report the active status to the analytics platform, the devices 102A-102N may generate a surrogate identifier that is sent to the analytics platform 120. In some implementations, the analytics platform 120 may send an indication to the devices 102A-102N that represents the length of the reporting period and/or the length of the frequency interval.

In some implementations, the surrogate identifiers 122A-122N may be generated using a cryptographic hashing function. In some implementations, the surrogate identifiers 122A-122N may be generated in part using a numerical identifier for a current reporting period. For example, if the reporting period has a length of one month and the current reporting period is April 2025, the surrogate identifier may be generated in part based on a numerical representation of “April 2025.”

In some implementations, the surrogate identifiers 122A-122N may function as the active status for the device 102A-102N. In some implementations, the surrogate identifiers 122A-122N are sent to the analytics platform 120 along with a portion of the activity history 123A-123N (e.g., as metadata). For example, a device 102A-102N may transmit a surrogate identifier along with an activity status for the current reporting period (e.g., April 2025), as well as activity statuses for the past three reporting periods (e.g., March 2025, February 2025, January 2025).

In some implementations, a device 102A-102N may not include a locally-stored activity history 123A-123N. For example, the device 102A-102N may not have previously been activated (e.g., used), or may have been reset. When a device 102A-102N does not have activity history 123A-123N, the device 102A-102N may send a query to the PSM module 121 that requests whether the device 102A-102N has previously sent an activity status to the analytics platform 120. The PSM 121 may determine whether the device 102A-102N has previously sent an activity status to the analytics platform 120 and send back a corresponding indication (e.g., a yes or no), along with recent activity history 123A-123N for the device. As described above, when the PSM 121 provides this data to the device 102A-102N, the PSM 121 is unable to determine which of the devices of the devices 102A-102N requested the information.

The lifecycle module 151 may receive the surrogate identifiers 122A-122N and/or associated activity history 123A-123N from the devices 102A-102N. The lifecycle module 151 may include lifecycle metrics 152, reporting periods 153, observation windows 154, and cohort identifiers 156. The lifecycle module 151 may determine lifecycle metrics 152 from the surrogate identifiers 122A-122N and/or associated activity history 123A-123N received from the devices 102A-102N. In some implementations, the lifecycle metrics 152 are calculated using one or more indications of the reporting period 153, the observation window 154, and/or the cohort identifier 156, as is further described herein.

The reporting period 153, as described above, refers to a time interval for which the device 102A-102N reports an activity status. As described above, the reporting period 153 may be one or more hours, days, weeks, months, or the like. An observation window 154 refers to a time interval for which an activity status of the devices 102A-102N is observed.

The observation window 154 is based on the reporting period 153. That is, a minimum length of the observation window 154 is one reporting period 153, and a length of the observation window 154 is equal to an integer multiple of one reporting period 153. The observation window 154 may be determined by the analytics platform 120, such as by the lifecycle module 151. In an illustrative example, a reporting period 153 may be one month, and an observation window 154 may be three months. In some implementations, the length of the observation window 154 may be adjusted based on an anticipated or expected usage pattern for the devices 102A-102N. For example, if a device 102A-102N is expected or anticipated to be used at least once every three months, and/or a device manufacturer using the analytics platform 120 would like to ascertain device usage and lifecycle metrics 152 as a three-month window, then the observation window 154, then the observation window 154 may be set to a length of three months. In some implementations, a length of the observation window 154 is based on a length of an initial observation window. In some implementations, during the initial observation window, devices 102A-102N that send an activity status are added to a cohort (e.g., identified by a cohort identifier 156, further described below). In such implementations, the length of the observation window 154 may be an integer multiple of the length of the initial observation window. In an illustrative example, if the initial observation window has a length of one month, then the observation window 154 may be set to a length of one month, two months, three months, etc.

In some implementations, a retention gap 155 is a time between the initial observation window and subsequent observation windows (e.g., observation windows 154). In some implementations, the length of the retention gap 155 is zero days. That is, in some implementations, an observation window may begin immediately following an initial reporting period or initial observation window. The retention gap 155 may be set by the analytics platform 120, such as by the lifecycle module 151.

The cohort identifiers 156 may identify devices 102A-102N whose device usage is tracked by the analytics platform 120. In some implementations, a group of devices are identified as a cohort by the analytics platform 120. This may be a subset of devices 102A-102N. In some implementations, a cohort identifier 156 corresponds to particular characteristics of devices or subsets of devices (e.g., of the devices 102A-102N), such as hardware characteristics (e.g., processor type, memory quantity, memory type, etc.), physical characteristics (device size, color, screen resolution, form-factor, etc.), software characteristics (e.g., operating system revision, firmware revision, etc.), use-case (e.g., educational, enterprise, consumer, etc.). That is, the lifecycle module 151 may generate different lifecycle metrics 152 based on various cohort identifiers 156 that are assigned to, or may be associated with devices 102A-102N. In some implementations, multiple cohort identifiers 156 may be associated with the same device. In some implementations, the lifecycle module 151 may send one or more requests to the devices 102A-102N to provide an activity status to the analytics platform 120. In such implementations, the lifecycle module 151 may assign a cohort identifier to the devices 102A-102N from which the activity statuses are requested. In some implementations, a cohort identifier 156 may be assigned to a subset of devices 102A-102N that report an activity status during an initial observation window.

In some implementations, when the lifecycle observation module 151 receives an activity status and stores it in the activity status table 157. The activity status table 157 stores activity history 123A-123N for each surrogate identifier 122A-122N that sends an activity status to the analytics platform 120. In some implementations, the activity status table 157 is stored in the data store 106. In some implementations, the activity status table 157 is a Fresnel database.

In some implementations, to calculate the lifecycle metrics 152, the lifecycle module 151 determines a current observation window and an initial observation window. In some implementations, the current observation window and the initial observation window are selected by a user of the analytics platform 120. In some implementations, the initial observation window is selected for a cohort of devices (e.g., identified by the cohort identifier), and the current observation window refers to the observation window to which a current date corresponds. For example, given a three-month observation window, the date “Apr. 18, 2025” may correspond to a first observation window (February 2025-April 2025), a second observation window (March 2025-May 2025), and a third observation window (April 2025-June 2025). The lifecycle metric 152 for these two times may be calculated as the number of devices that are active in the current observation window that were also active in the initial observation window, in comparison to the number of devices that were active in the initial observation window.

$$LifecycleMetric = 1 - \frac{{D}_{C} ∈ {D}_{I}}{{D}_{I}}$$

where D_{C} is the number of devices in the current observation window, and D_{I} is the number of devices in the initial observation window.

Thus, the lifecycle module 151 may calculate a likelihood that devices 102A-102N are being “churned,” that is reaching an end of the device's lifecycle and being replaced. This information may be used by device manufacturers to estimate how many devices to produce. For example, at the launch of a new device, this information may be used to determine, in part, how many devices will be needed in inventory to meet a projected demand. In another example, this information may be used after the device has been manufactured for a period of time to increase or decrease the quantity of devices that are manufactured.

The devices 102A-102N may each include computing devices such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, devices 102A-102N may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, devices 102A-102N may also be referred to as “user devices.” Each device 102A-102N may include an audiovisual component that may generate audio and video data to be streamed to analytics platform 120. In some implementations, the audiovisual component may include a device (e.g., a microphone) to capture an audio signal representing speech of a user and generate audio data (e.g., an audio file or audio stream) based on the captured audio signal. The audiovisual component may include another device (e.g., a speaker) to output audio data to a user (e.g., a virtual meeting participant) associated with a particular device. In some implementations, the audiovisual component may also include an image capture device (e.g., a camera) to capture images and generate video data (e.g., a video stream) of the captured data of the captured images.

In some implementations, the devices 102A-102N may implement or include one or more applications to communicate (e.g., send and receive information) with the analytics platform 120. In some implementations, the devices 102A-102N may implement a user interface (UI) (e.g., graphical user interfaces (GUIs)), such as a UI 124A-124N) that may be webpages rendered by a web browser and displayed on the devices 102A-102N in a web browser window. In another implementation, the UI 124A-124N of the devices 102A-102N may be included in a stand-alone application downloaded to the devices 102A-102N and natively running on the devices 102A-102N (also referred to as a “native application” or “native client application” herein). In some implementations, some or all portions of the private audio module 151 may be implemented at the device 102A-102N.

Each device 102A-102N may include a browser and/or a client application (e.g., a mobile application, a desktop application, etc.). In some implementations, the web browser and/or the client application may present, on a display device of device 102A-102N, a user interface (UI).

In some implementations, a device 102A may access the analytics platform 120 through network 108 using one or more application programming interface (API) calls via platform API endpoint 129. In some implementations, analytics platform 120 may include multiple platform API endpoints 129 that may expose services, functionality, or information of the analytics platform 120 to one or more devices 102A-102N. In some implementations, a platform API endpoint 129 may be one end of a communication channel, where the other end may be another system, such as a device 102A associated with a participant or user account. In some implementations, the platform API endpoint 129 may include or be accessed using a resource locator, such a universal resource identifier (URI), universal resource locator (URL), of a server or service. The platform API endpoint 129 may receive requests from other systems, and in some cases, return a response with information responsive to the request. In some implementations, HTTP (Hypertext Transfer Protocol), HTTPS (Hypertext Transfer Protocol Secure) methods (e.g., API calls) may be used to communicate to and from the platform API endpoint 129.

In some implementations, the platform API endpoint 129 may function as a computer interface through which access requests are received and/or created. In some implementations, the platform API endpoint 129 may include a platform API whereby external entities or systems may request access to services and/or information provided by the analytics platform 120. The platform API may be used to programmatically obtain services and/or information associated with a request for services and/or information.

In some implementations, the API of the platform API endpoint 129 may be any suitable type of API such as a REST (Representational State Transfer) API, a GraphQL API, a SOAP (Simple Object Access Protocol) API, and/or any suitable type of API. In some implementations, the analytics platform 120 may expose through the API, a set of API resources which when addressed may be used for requesting different actions, inspecting state or data, and/or otherwise interacting with the analytics platform 120. In some implementations, a REST API and/or another type of API may work according to an application layer request and response model. An application layer request and response model may use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the analytics platform 120 may observe the principals of a RESTful design or the protocol of the type of API. RESTful is understood in this document to describe a Representational State Transfer architecture. The RESTful HTTP requests may be stateless, thus each message communicated contains all information used for processing the request and generating a response. The platform API may include various resources, which act as endpoints that may specify requested information or requesting particular actions. The resources may be expressed as URI's or resource paths. The RESTful API resources may additionally be responsive to different types of HTTP methods such as GET, PUT, POST and/or DELETE.

It may be appreciated that in some implementations, any element, such as servers in the system 100 (e.g., a server hosting the analytics platform 120), and/or data store 106 may include a corresponding API endpoint for communicating with APIs.

In some implementations, analytics platform 120 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a virtual meeting. Analytics platform 120 may also include a website (e.g., a webpage) or application back-end software that may be used to enable a user to view, collect, edit, export, or process the lifecycle metrics 152.

It is appreciated that in some other implementations, the functions of the analytics platform 120 may be provided by a fewer number of machines. For example, in some implementations, analytics platform 120 may be integrated into a single machine, while in other implementations, analytics platform 120 may be integrated into multiple machines.

In general, functions described in implementations as being performed by analytics platform 120 may also be performed by the devices 102A-102N in other implementations, if appropriate. In addition, the functionality attributed to a particular component may be performed by different or multiple components operating together. Analytics platform 120 may also be accessed as a service provided to other systems or devices through appropriate application programming interfaces, and thus is not limited to use in websites.

In situations in which the systems discussed here collect personal information about users, or may make use of personal information, the users may be provided with an opportunity to control whether analytics platform 120 collects user information (e.g., information about a user's social network, social actions or activities, profession, a user's preferences, or a user's current location), or to control whether and/or how to receive content from the analytics platform 120 that may be more relevant to the user. In addition, certain data may be treated in one or more ways before it is stored or used, so that personally identifiable information is removed. For example, a user's identity may be treated so that no personally identifiable information may be determined for the user, or a user's geographic location may be generalized where location information is obtained (such as to a city, ZIP code, or state level), so that a particular location of a user cannot be determined. Thus, the user may have control over how information is collected about the user and used by the analytics platform 120.

Implementations described herein may involve the collection of data describing a user and/or activities of a user. To address the privacy of users, various techniques may be implemented. In one implementation, the collection of such data occurs only after the user provides consent. In some implementations, a user may be presented with a prompt to explicitly allow the collection of this data. In the instance where the user consents to the use of such data, the data may be used for the described functionalities.

Data representing a user identity that is collected at the devices 102A-102N is not shared with the lifecycle module 151, and cannot be derived from the surrogate identifier 122A-122N that is sent to the lifecycle module 151. Additionally, because of the use of the PSM module 121, any uniquely identifying device information (e.g., the unique identifier 103A, the unique identifier 103N, etc.) is only received once at the PSM module 121, and thus cannot be used again to derive any user information. Thus, the methods described in the present disclosure do not adversely affect the user's privacy. In some implementations, prior to the system enabling collection of user information (e.g., device metrics), a user may be provided with controls allowing the user to make an election as to both if and when the system may enable such collection.

In some implementations, users may be informed of the security measures in place to protect their information when device metrics are collected and/or analyzed at the analytics platform 120. Information regarding how long device information may be retained and the procedures for their removal may also be provided. Users may be informed of their options regarding their device metric collection information. Contact information for privacy-related questions may be made available.

Users may have the ability to review what data is sent or collected for their device. Information for calculating aggregated device analytics may be temporary. Data describing device information may be retained only for the minimum duration required for meeting functionality and may be removed shortly after the meeting concludes unless an affirmative indication is provided for longer retention to potentially improve future accuracy. The use of device information may be limited to the purpose of determining a device churn-factor (e.g., a replacement rate for devices 102A-102N).

Data describing relevant device characteristics may be treated in one or more ways before it is stored or used, so that personally identifiable information is removed. For example, a user's identity may be treated so that no personally identifiable information may be determined for the user. Access to stored facial feature data may be controlled to limit which components and personnel may access it.

The system may be designed to align with privacy considerations. Privacy considerations may be addressed in the design of application programming interfaces (APIs), such as not retaining detailed data in logs and enforcing strong security for data retrieval. A description of the retention periods and data removal procedures for all collected and processed data related to this system may be documented.

Workspace administrators may be provided with controls to manage implementations within their domain, including the ability to enable or disable it for specific units or users and potentially remove enrollment data. Features for reviewing the usage of automatic identification may be implemented to support accountability.

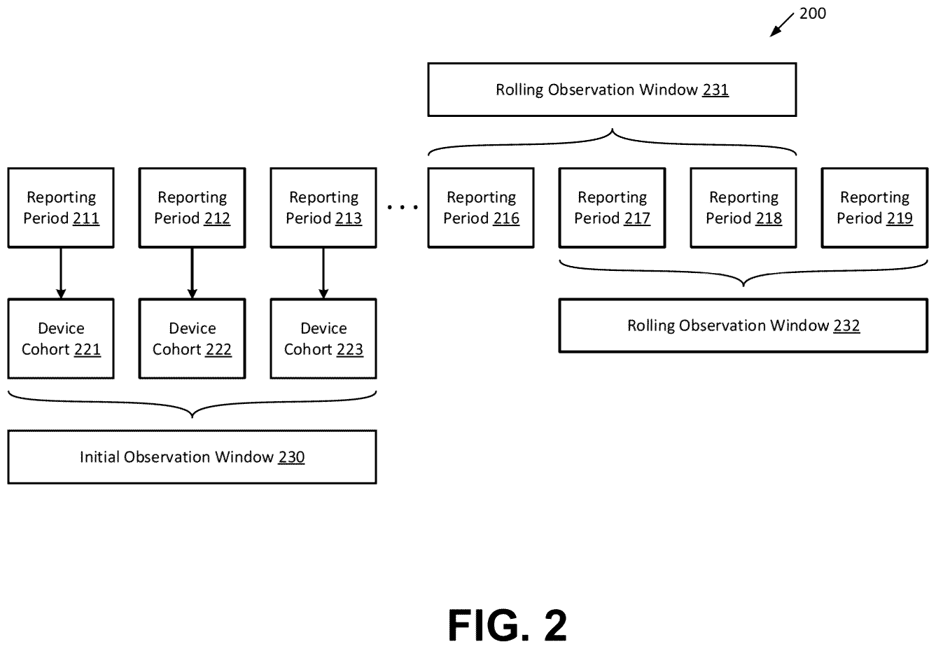

FIG. 2 is an example block diagram 200, illustrating the relationship between reporting periods, observation windows, and device cohorts, according to some aspects of the present disclosure.

As illustrated, the device cohort 221 may be assigned to the reporting period 211, device cohort 222 may be assigned to the reporting period 212, and device cohort 223 may be assigned to the reporting period 213. These three reporting periods may constitute an initial observation window 230. As used herein, “device cohort” may refer to the number of unique devices that report an activity status for a particular reporting period (e.g., a number of the devices 102A-102N). After the initial observation window 230, subsequent rolling observation windows may monitor the lifecycle metrics for the device cohorts 221, 222, 223, such as in subsequent reporting periods, such as reporting period 216, reporting period 217, reporting period 218 and reporting period 219. As illustrated, the rolling observation window 231 may include the reporting period 216, the reporting period 217, and the reporting period 218. The rolling observation window 232 may include the reporting period 217, the reporting period 218, and the reporting period 219. As described above, lifecycle metrics 152 may be determined for any observation window (e.g., rolling observation window 231, rolling observation window 232, etc.).

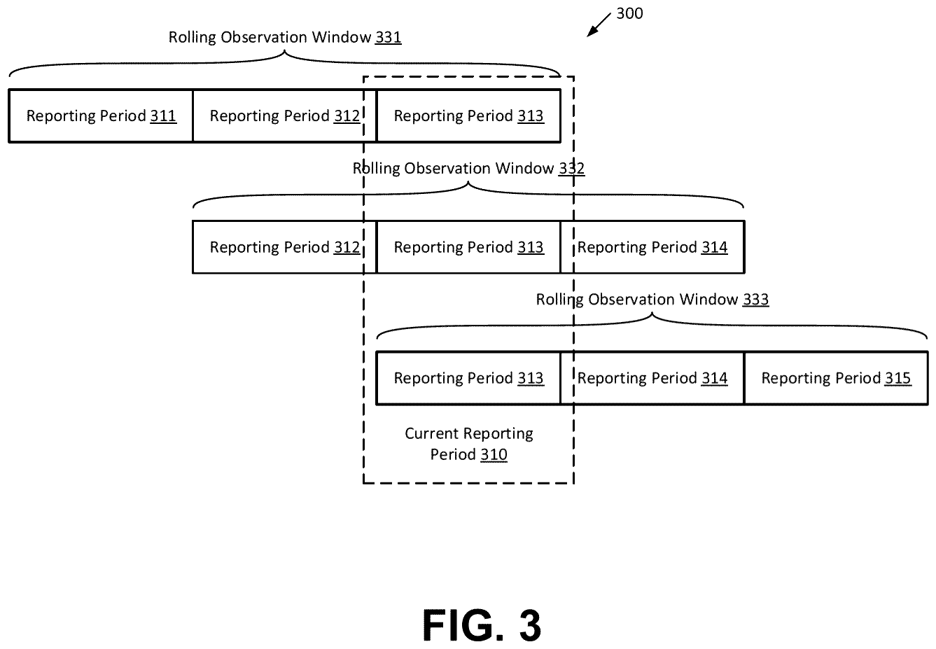

FIG. 3 is an example block diagram 300, illustrating activity history saved for a device in a private set membership (PSM) module, such as the PSM module 121 of FIG. 1, according to some aspects of the disclosure.

For each unique device identifier (e.g., unique identifier 103A-103N of FIG. 1), the PSM module 121 may save a predetermined number of reporting period activity statuses. As illustrated, since the rolling observation window 331 spans three reporting periods (e.g., reporting period 311, reporting period 312, and reporting period 313), the PSM module 121 may save at least three activity status indicators for each unique device identifier. In other implementations, larger or smaller sizes of the rolling observation window 331 are considered.

When a device does not have a local history of sending activity statuses to the analytics platform 120 in the current reporting period 310, such as when the device is first activated or when the device has recently been reset, the device may send a query to the PSM module 121 to determine whether the device has previously provided an activity status to the analytics platform 120. In some implementations, the query to the PSM module 121 is a copy of the surrogate identifier. The PSM module 121 receives the surrogate identifier as an encrypted message, and provides a hash back to the device that sent the surrogate identifier. Upon decrypting the hash from the PSM module 121, the device that sent the surrogate identifier may determine whether the surrogate identifier is included in the private set of surrogate identifiers managed by the PSM module 121. In some implementations, the device may send surrogate identifiers corresponding to each reporting period for which the device does not have locally stored activity history. The PSM module 121 may respond with respective hashes to each sent surrogate identifier, and the device may determine by decrypting each hash, whether an activity status was reported for the device during the respective reporting period.

As illustratively illustrated, since the rolling observation window 331 includes three reporting periods, and subsequent rolling observation windows will span the same number of reporting periods (e.g., the observation window 332 for reporting period 312, reporting period 313, and reporting period 314, and the observation window 333 for reporting period 313, reporting period 314, and reporting period 315, respectively), the device will send three check-membership requests to the PSM module 121 to determine, for each rolling observation window, whether an activity status was reported for the device. Each check-membership request is sent for the respective rolling observation window that intersects with the current reporting period 310. Thus, in implementations with larger or smaller rolling observation windows, the number of check-membership requests sent by the device to the PSM module will be smaller or larger, respectively. For example, given a rolling observation window with length of six reporting periods, the device 102A-102N would send six separate check-membership requests to the PSM module 121, one for each of the six rolling observation windows that intersected the current reporting period (not illustrated).

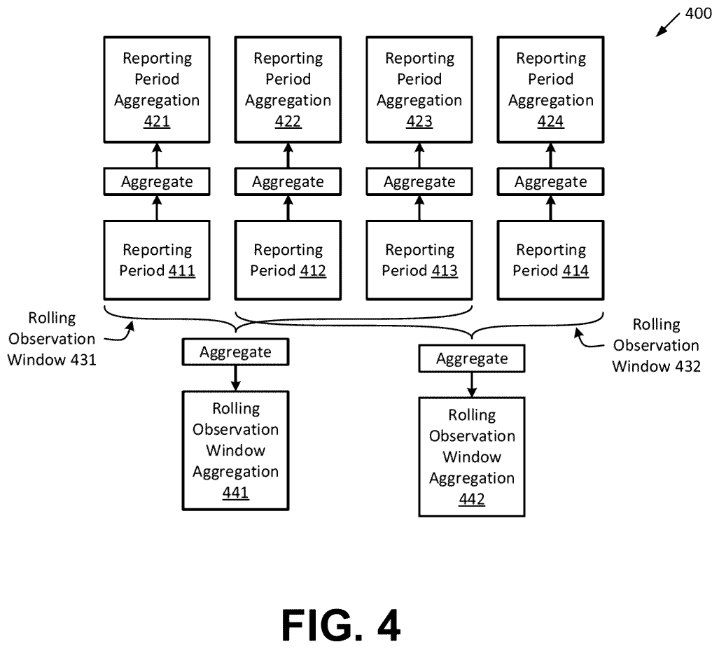

FIG. 4 is an example block diagram 400 illustrating how data is ingested into the analytics platform 120 and used by the lifecycle module 151 to calculate lifecycle metrics 152, according to some aspects of the disclosure.

For the reporting period 411, a reporting period aggregation pipeline aggregates each activity status associated with a unique surrogate identifier 123A-123N that is received at the analytics platform 120 to generate the reporting period aggregation 421. Similarly, the reporting period aggregation pipeline aggregates activity statuses received at the reporting period 412 into reporting period aggregation 422, the activity status received at the reporting period 413 into reporting period aggregation 423, and the activity status received at the reporting period 414 into reporting period aggregation 424.

For the rolling observation window 431, 432, an observation window aggregation pipeline aggregates the activity statues received for the entire observation window (e.g., for any of the reporting period 411, 412, 413) into the rolling observation window aggregation 441. Similarly, for the rolling observation window 431, 432, the observation window aggregation pipeline aggregates the activity statues for the entire observation window (e.g., for any of the reporting periods 412, 413, 414) into the rolling observation window aggregation 442.

The reporting period aggregation values (e.g., reporting period aggregation 421, 422, 423, 424) and the rolling observation window aggregation values (e.g., rolling observation window aggregation 441, 442) may be used by the lifecycle module 151 to calculate one or more lifecycle metrics 152.

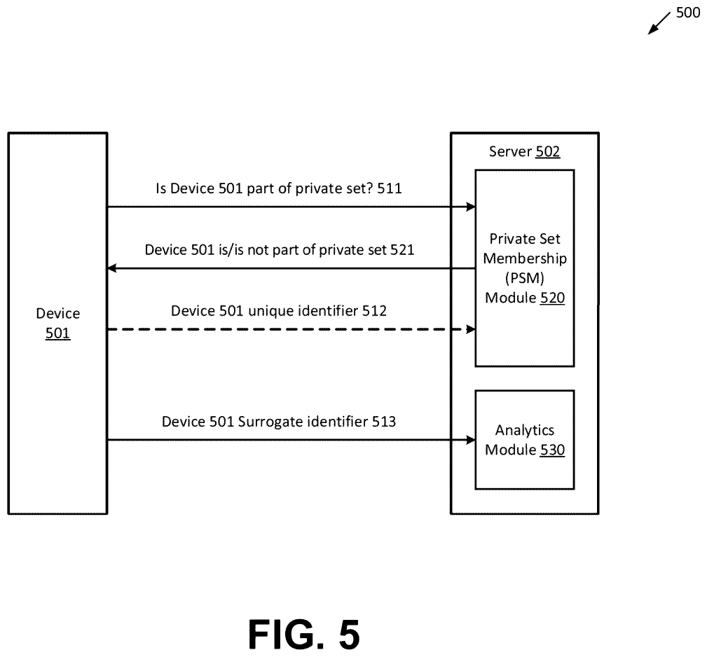

FIG. 5 is a block diagram 500 illustrating a communication flow between a device 501, such as the devices 102A-102N of FIG. 1, and a server 502, such as the analytics platform 120 of FIG. 1, according to some aspects of the disclosure.

If the device 501 has a locally stored activity history 123A-123N, the communications 511, 512, 513 are not sent. That is, if the device 501 has a locally stored activity history 123A-123N, then the device 501 does not communicate with the PSM module 520.

Notably, for the communications 511, 512, 513 described below, the device 501 and the PSM module 520 of the server 502 communicate with encrypted communications such that the PSM module 520 does not receive a plaintext of the unique identifier 103A-103N of the device 501, but is still enabled to check the membership of the device 501 in a specified set of devices. It does this by checking whether the surrogate identifier is part of a private set of surrogate identifiers that have previously been sent to the PSM module.

In some implementations, the communications 511 and 512 are the same communication. That is, the device 501 may send the surrogate identifier in the communication 511, and the PSM module 520 may respond in the communication 521 with hash, which when decrypted by the device 501, allows the device 501 to determine whether the surrogate identifier is included in the private set managed by the PSM module 520.

When the device 501 does not have a locally stored activity history 123A-123N, at communication 511 the device 501 requests the activity history 123A-123N for the device 501 from the PSM module 520 of the server 502. In some implementations, the communication 511 is a check-membership request for a current reporting period, as described above with reference to FIG. 3. As described with reference to FIG. 3, in some implementations, the device 501 sends multiple communications 511 (e.g., check-membership requests) to the PSM module 520, each corresponding to a respective observation window (e.g., rolling observation windows 331, 332, 333) that intersect the current reporting period 310.

In response to receiving the communication 511 from the device 501, the server 502 sends a communication 521 to the device 501. The communication 521 indicates whether the device 501 is a member (e.g., part of) a group of devices 102A-102N, that have previously reported an activity status to the analytics module 530 of the server 502. If the device 502 has previously reported an activity status to the analytics module 530, then the PSM module 520 sends the indication that the device 501 has membership in the group of devices (e.g., “yes.”). If the device 502 has not previously reported an activity status to the analytics module 520, then the PSM module 520 sends the indication that the device 501 does not have membership in the group of devices (e.g., “no”).

If the PSM module 520 cannot verify the membership of the device 501 in the group of tracked devices, then the communication 512 indicates a “no.” In response to this indication, the device 501 sends the communication 512 which includes the surrogate identifier 122A-122N representing the unique identifier 103A-103N for the device 501 and a reporting period. Notably, in some implementations, the communication 512 from the device 501 is sent to the PSM module 520 only once during the lifetime of the device 501. As used herein, “lifetime” may refer to the use of the device 501 anytime after an activation of the device 501. Thus, even if the device 501 has been reset (e.g., returned to factory-default settings), the communication 512 if the communication 512 has already been sent, it will not be sent again.

Once the device 501 has a locally stored activity history 123A-123N, the device 501 sends a communication 513 to the analytics module 530 of the server 502 based on the locally stored activity history 123A-123N. In some implementations, if the locally stored activity history 123A-123N indicates that an activity status of the device 501 has already been sent during the current reporting period 310, the device 501 refrains from sending the communication 513. In some implementations, if the locally stored activity history 123A-123N indicates that an activity status of the device 501 has not already been sent during the current reporting period 310, the device 501 sends the communication 513 that includes the surrogate identifier 122A-122N for the device 501. In some implementations, the surrogate identifier for the device 501 (e.g., surrogate identifier 122A-122N) is generated from a hardware identifier (e.g., unique identifier 103A-103N) using a cryptographic algorithm, as described above.

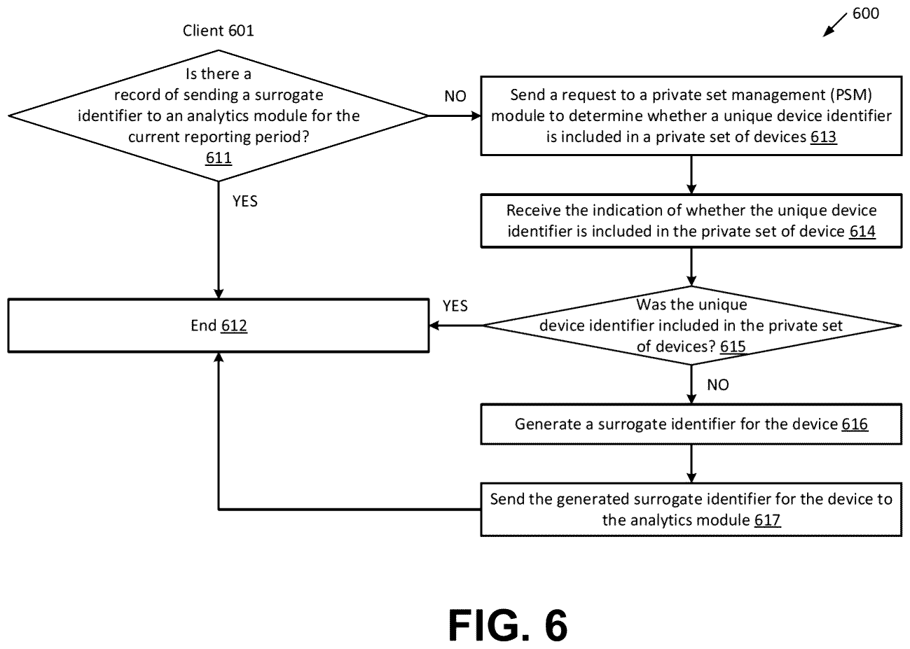

FIG. 6 is a flow diagram of an example method 600 for privacy-preserving lifecycle tracking for computing devices, according to some aspects of the disclosure. The method 600 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes may be modified. Thus, the illustrated implementations should be understood only as examples, and the illustrated processes may be performed in a different order, and some processes may be performed in parallel. Additionally, one or more processes may be omitted in various implementations. Thus, not all processes are required in every implementation. Other process flows are possible.

At operation 611, the processing logic of the client 601 performing the method 600 determines if there is a record (e.g., activity history 123A-123N) of sending a surrogate identifier (e.g., surrogate identifier 122A-122N) to an analytics platform (e.g., analytics platform 120) for the current reporting period (e.g., current reporting period 310).

Responsive to determining that there is an activity history 123A-123N that indicates that a surrogate identifier 122A-122N for the client 601 has already been sent to the analytics platform 120 for the current reporting period 310 (e.g., “YES”), the processing logic proceeds to operation 612, which ends the method 600.

Responsive to determining that is is not an activity history 123A-123N that indicates that a surrogate identifier 122A-122N for the client 601 has been sent to the analytics platform 120 for the current reporting period 310 (e.g., “NO”), the processing logic proceeds to operation 613.

At operation 613, the processing logic of the client 601 sends a request to a private set membership (PSM) module to determine whether a unique device identifier (e.g., unique identifier 103A-103N) for the client 601 is included in a private set of devices. In some implementations, the unique identifier 103A-103N for the client 601 is included in the private set of devices if the client 601 has previously sent the unique identifier 103A-103N to the PSM module (e.g., such as in a communication 512 described with reference to FIG. 5).

At operation 614, the processing logic of the client 601 receives an indication from the PSM module of whether the unique identifier 103A-103N is included in the private set of devices.

At operation 615, if the unique identifier 103A-103N is included in the private set of devices (e.g., “YES”), then the processing logic proceeds to the operation 612, which ends the method 600. If the unique identifier 103A-103N is not included in the private set of devices (e.g., “NO”), then the processing logic proceeds to operation 616.

At operation 616, the processing logic of the client 601 generates a surrogate identifier for the client 601 (e.g., surrogate identifier 122A-122N).

At operation 617, the processing logic of the client 601 sends the generated surrogate identifier for the client 601 to the analytics module.

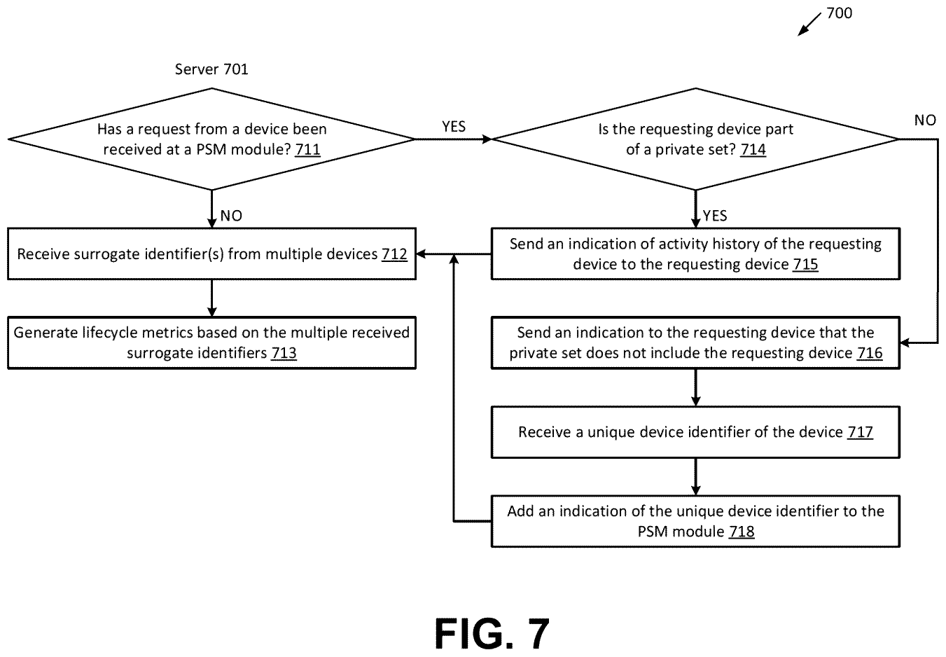

FIG. 7 is a flow diagram of an example method 700 for privacy-preserving lifecycle observation for computing devices, according to some aspects of the disclosure. The method 700 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes may be modified. Thus, the illustrated implementations should be understood only as examples, and the illustrated processes may be performed in a different order, and some processes may be performed in parallel. Additionally, one or more processes may be omitted in various implementations. Thus, not all processes are required in every implementation. Other process flows are possible.

At operation 711 the processing logic of the server 701 performing the method 700 determines whether a request has been received from a device (e.g., devices 102A-102N) at the PSM module (e.g., PSM module 121) of the server 701. Responsive to determining that a request has not been received (e.g., “NO”), the processing logic proceeds to operation 712. Responsive to determining that a request has been received (e.g., “YES”), the processing logic proceeds to operation 714.

At operation 712, the processing logic of the server 701 receives one or more surrogate identifiers from devices (e.g., device 102A-102N).

At operation 713, the processing logic of the server 701 generates lifecycle metrics based on the received surrogate identifiers.

At operation 714, responsive to determining that a request has been received at the PSM module from a device 102A-102N, the processing logic of the server 701 determines whether the requesting device is part of a private set. If the device 102A-102N is part of the private set (e.g., “YES”), the processing logic proceeds to operation 715. If the device 102A-102N is not part of the private set (e.g., “NO”), the processing logic proceeds to operation 716.

At operation 715, the processing logic of the server 701 sends an indication of activity history of a requesting device to the requesting device. In some implementations, the activity history is sent as described above with reference to FIGS. 3-4. After operation 715, the processing logic of the server 701 proceeds to operation 712, described above.

At operation 716, the processing logic of the server 701 sends an indication to the requesting device that the private set does not include the requesting device.

At operation 717, the processing logic of the server 701 receives a unique device identifier for the requesting device.

At operation 718, the processing logic of the server 701 adds an indication of the unique device identifier to the PSM module.

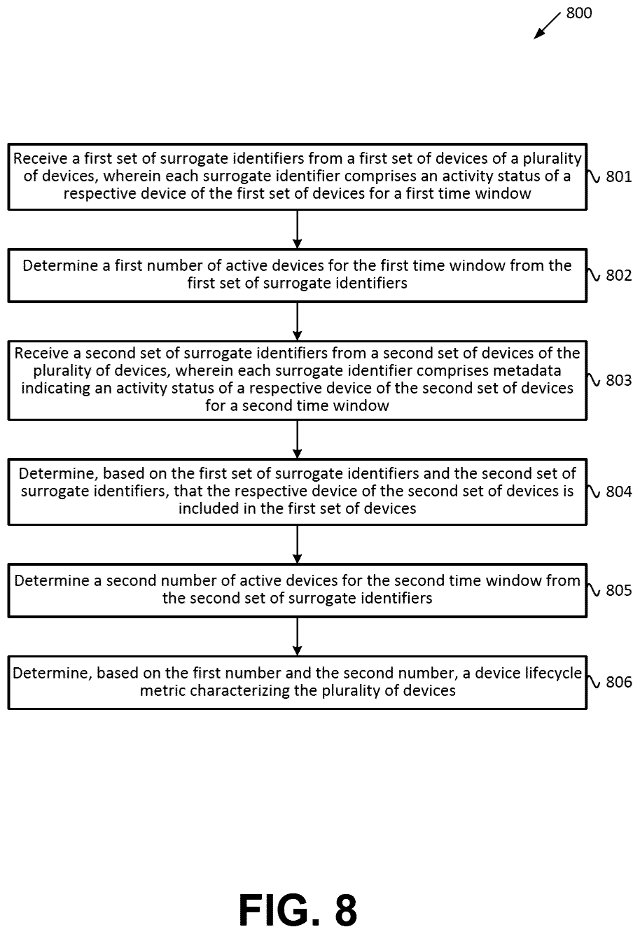

FIG. 8 is a flow diagram of an example method 800 for privacy-preserving lifecycle tracking for computing devices, according to some aspects of the disclosure. The method 800 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes may be modified. Thus, the illustrated implementations should be understood only as examples, and the illustrated processes may be performed in a different order, and some processes may be performed in parallel. Additionally, one or more processes may be omitted in various implementations. Thus, not all processes are required in every implementation. Other process flows are possible.

At operation 801, the processing logic performing the method 800, receives a first set of surrogate identifiers from a first set of devices of a plurality of devices, wherein each surrogate identifier comprises an activity status of a respective device of the first set of devices for a first time-window.

At operation 802, the processing logic determines a first number of active devices for the first time-window from the first set of surrogate identifiers.

At operation 803, the processing logic receives a second set of surrogate identifiers from a second set of devices of the plurality of devices, wherein each surrogate identifier comprises metadata indicates an activity status of a respective device of the second set of devices for a second time-window.

At operation 804, the processing logic determines, based on the first set of surrogate identifiers and the second set of surrogate identifiers, that the respective device of the second set of devices is included in the first set of devices. In some implementations, determining that the respective device of the second set of devices is included in the first set of devices includes determining whether an observation window aggregation spanning the first time-window and the second time-window includes the respective device of the second set of devices.

At operation 805, the processing logic determines a second number of active devices for the second time-window from the second set of surrogate identifiers.

At operation 806, the processing logic determines, based on the first number and the second number, a device lifecycle metric that characterizes the plurality of devices. The lifecycle metric may represent a number of devices that were active in the first time-window that are still active in the second time-window.

In some implementations, the processing logic further sends a cohort identifier to the multiple devices. In some implementations each surrogate identifier is generated from the cohort identifier. For example, the unique hardware identifier for the device and the cohort identifier for the group of devices that includes the device may be used as seeds in a cryptographic function that generates a pseudo-random identifier value.

In some implementations, the processing logic maintains a data structure that includes multiple data items. Each data item may include a device identifier (e.g., a unique device identifier) and device metadata associated with the device identifier (e.g., an activity history, such as a “YES/NO” indication for a particular reporting period. In some implementations, the processing logic receives an encrypted query from the respective device at the data structure. In some implementations, the encrypted query inquires whether the data structure comprises a respective device identifier for the respective device. In some implementations, responsive to determining that the data structure comprises the respective device identifier, the processing logic permits the respective device to access respective device metadata associated with the respective device identifier. For example, the activity status associated with the respective device identifier may be provided upon a determination that the device is a part of the group (e.g., “cohort”) of devices.

In some implementations, responsive to determining that the data structure does not comprise a respective device identifier, the processing logic receives, from the device, the respective device identifier. The processing logic may generate a data item including the respective physical device identifier of the respective device and the respective device metadata. The processing logic may add the data item to the data structure. In some implementations, the device metadata associated with the device identifier includes one or more device activity statuses corresponding to one or more respective reporting period for the respective device having the respective device identifier. In some implementations, the device metadata associated with the device identifier includes one or more device activity statuses corresponding to one or more respective reporting period for the respective device having the respective device identifier. In some implementations, generating the data item includes setting values of an activity history for the respective device to a default value. The activity history may include an indication for each reporting period that an activity status was received from the respective device.

In some implementations, the processing logic receives a third set of surrogate identifiers from a third set of devices of the plurality of devices. Each surrogate identifier may include metadata indicating an activity status of a respective device of the third set of devices for a third time-window. The processing logic determines, based on the third set of surrogate identifiers and at least one of: the first set of surrogate identifiers or the second set of surrogate identifiers, that the respective device of the third set of devices is included in the first set of devices and the second set of devices. The processing logic determines a third number of active devices for the third time-window from the third plurality of surrogate identifiers. The processing logic determines, based on the first number and the third number, a third device lifecycle metric. In some implementations, the second lifecycle metric and the third lifecycle metric may be used to determine an average lifecycle metric. In some implementations, the average lifecycle metric is a rolling average lifecycle metric.

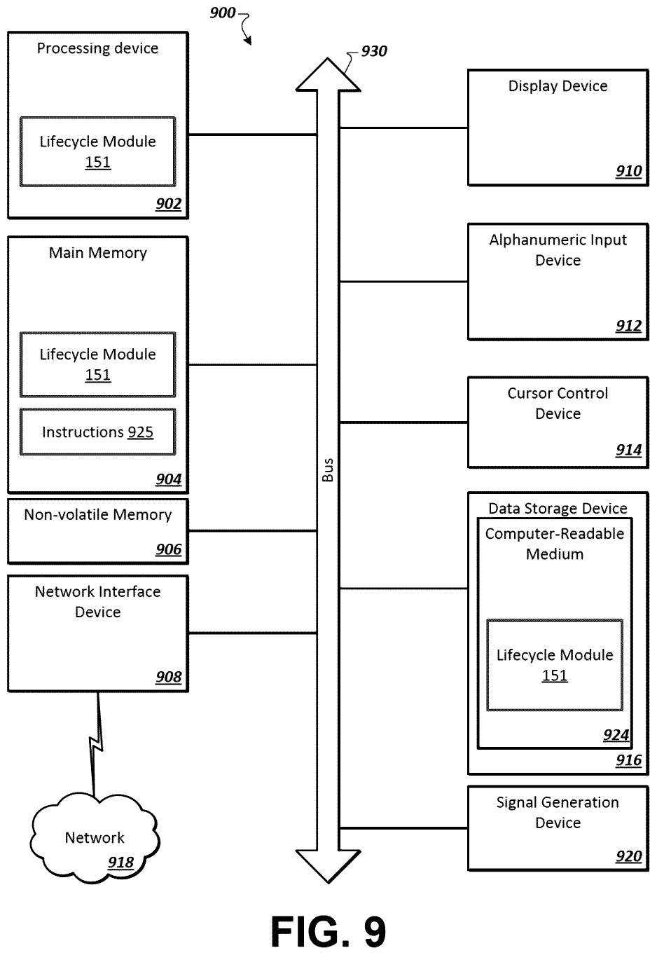

FIG. 9 is a block diagram illustrating an example of a computer system 900, according to aspects of the disclosure. The computer system 900 may correspond to analytics platform 120 and/or devices 102A-102N, described in FIG. 1. Computer system 900 may operate in the capacity of a server or an endpoint machine in an endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 900 includes a processing device 902 (e.g., a processor), a main memory 904 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 906 (e.g., flash memory, static random access memory (SRAM), etc.), and a data storage device 916, which communicate with each other via a bus 930. In some implementations, the main memory 904 may be a non-transitory computer readable storage medium.

Processing device 902 represents one or more general-purpose processing devices such as a microprocessor, central processing unit, or the like. More specifically, processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute network interface device 908 (e.g., for synchronizing data between platforms) for performing the operations discussed herein. The processing device 902 may be configured to execute instructions 925 stored in main memory 904. Non-volatile memory 906 may store the instructions 925 when they are not being executed, and may store additional system data that may be accessed by processing device 902. As illustrated, in some implementations, the processing device 902 may include a lifecycle module 151.

The computer system 900 may further include a network interface device 908. The computer system 900 also may include a video display unit 910 (e.g., a liquid crystal display (LCD) or a cathode ray tube (CRT)), an input device 912 (e.g., a keyboard, and alphanumeric keyboard, a motion sensing input device, touch screen), a cursor control device 914 (e.g., a mouse), and a signal generation device 918 (e.g., a speaker).

The data storage device 916 may include a computer-readable storage medium 924 (e.g., a non-transitory machine-readable storage medium) on which one or more sets of instructions 925 is stored (e.g., for generating variations of a translated audio portion), embodying any one or more of the methodologies or functions described herein. The instructions may also reside, completely or at least partially, within the main memory 904 and/or within the one or more processing devices (e.g., the processing device 902) during execution thereof by the computer system 900, the main memory 904 and the processing device 902 also constituting machine-readable storage media. The instructions may further be transmitted or received over a network 920 via the network interface device 908. In some implementations, one or more processing devices may be operatively coupled to the main memory 904 to perform various operations. As illustrated, in some implementations, the main memory 904 may include a lifecycle module 151.

While the computer-readable storage medium 924 (non-transitory computer-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media. As illustrated, in some implementations, the computer-readable medium may include a lifecycle module 151.

Reference throughout this specification to “one implementation,” “one implementation,” “an implementation,” or “an implementation,” means that a specific feature, structure, or characteristic described in connection with the implementation and/or implementation is included in at least one implementation and/or implementation. Thus, the appearances of the phrase “in one implementation,” or “in an implementation,” in various places throughout this specification may, but are not necessarily, referring to the same implementation, depending on the circumstances. Furthermore, the specific features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller may be a component. One or more components may reside within a process and/or thread of execution and a component may be localized on one computer and/or distributed between two or more computers. Further, a “device” may come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It may be appreciated that such systems, circuits, components, blocks, and so forth may include those components or specified sub-components, some of the specified components or sub-components, and/or additional components, and according to various permutations and combinations of the foregoing. Sub-components may also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving a first set of surrogate identifiers from a first set of devices of a plurality of devices, wherein each surrogate identifier comprises an activity status of a respective device of the first set of devices for a first time-window;
determining a first number of active devices for the first time-window from the first set of surrogate identifiers;
receiving a second set of surrogate identifiers from a second set of devices of the plurality of devices, wherein each surrogate identifier comprises metadata indicating an activity status of a respective device of the second set of devices for a second time-window;
determining, based on the first set of surrogate identifiers and the second set of surrogate identifiers, that the respective device of the second set of devices is included in the first set of devices;
determining a second number of active devices for the second time-window from the second set of surrogate identifiers; and
determining, based on the first number and the second number, a first device lifecycle metric characterizing the plurality of devices.

2. The method of claim 1, further comprising:
sending a cohort identifier to the plurality of devices, wherein each surrogate identifier of the first plurality of surrogate identifiers and each surrogate identifier of the second plurality of surrogate identifiers are generated based on the cohort identifier.

3. The method of claim 1, further comprising:
maintaining a data structure comprising a plurality of data items, wherein each data item comprises:
a device identifier, and
device metadata associated with the device identifier;
receiving an encrypted query from the respective device at the data structure, wherein the encrypted query inquires whether the data structure comprises a respective device identifier for the respective device; and
responsive to determining that the data structure comprises the respective device identifier, permitting the respective device to access respective device metadata associated with the respective device identifier.

4. The method of claim 3, further comprising:
responsive to determining that the data structure does not comprise a respective device identifier, receiving, from the device, the respective device identifier;
generating a data item comprising the respective device identifier of the respective device and the respective device metadata; and
adding the data item to the data structure.

5. The method of claim 3, wherein the device metadata associated with the device identifier comprises:
one or more device activity statuses corresponding to one or more respective reporting period for the respective device having the respective device identifier.

6. The method of claim 5, wherein generating the data item further comprises:
setting values of an activity history for the respective device to a default value, wherein the activity history includes an indication for each reporting period that an activity status was received from the respective device.

7. The method of claim 1, further comprising:
receiving a third set of surrogate identifiers from a third set of devices of the plurality of devices, wherein each surrogate identifier comprises metadata indicating an activity status of a respective device of the third set of devices for a third time-window;
determining, based on the third set of surrogate identifiers and at least one of: the first set of surrogate identifiers or the second set of surrogate identifiers, that the respective device of the third set of devices is included in the first set of devices and the second set of devices;
determining a third number of active devices for the third time-window from the third plurality of surrogate identifiers; and
determining, based on the first number and the third number, a second device lifecycle metric.

8. The method of claim 7, further comprising:
determining, based on the second device lifecycle metric and the first device lifecycle metric, a rolling average lifecycle metric.

9. The method of claim 1, wherein determining that the respective device of the second set of devices is included in the first set of devices comprises:
determining whether an observation window aggregation spanning the first time-window and the second time-window includes the respective device of the second set of devices.

10. A system comprising:
a memory; and
one or more processing devices communicatively coupled with the memory, the one or more processing devices to perform operations comprising:
receiving a first set of surrogate identifiers from a first set of devices of a plurality of devices, wherein each surrogate identifier comprises an activity status of a respective device of the first set of devices for a first time-window;
determining a first number of active devices for the first time-window from the first set of surrogate identifiers;
receiving a second set of surrogate identifiers from a second set of devices of the plurality of devices, wherein each surrogate identifier comprises metadata indicating an activity status of a respective device of the second set of devices for a second time-window;
determining, based on the first set of surrogate identifiers and the second set of surrogate identifiers, that the respective device of the second set of devices is included in the first set of devices;
determining a second number of active devices for the second time-window from the second set of surrogate identifiers; and
determining, based on the first number and the second number, a first device lifecycle metric characterizing the plurality of devices.

11. The system of claim 10, the operations further comprising:
sending a cohort identifier to the plurality of devices, wherein each surrogate identifier of the first plurality of surrogate identifiers and each surrogate identifier of the second plurality of surrogate identifiers are generated based on the cohort identifier.

12. The system of claim 10, the operations further comprising:
maintaining a data structure comprising a plurality of data items, wherein each data item comprises:
a device identifier, and
device metadata associated with the device identifier;
receiving an encrypted query from the respective device at the data structure, wherein the encrypted query inquires whether the data structure comprises a respective device identifier for the respective device; and
responsive to determining that the data structure comprises the respective device identifier, permitting the respective device to access respective device metadata associated with the respective device identifier.

13. The system of claim 12, the operations further comprising:
responsive to determining that the data structure does not comprise a respective device identifier, receiving, from the device, the respective device identifier;
generating a data item comprising the respective device identifier of the respective device and the respective device metadata; and
adding the data item to the data structure.

14. The system of claim 12, wherein the device metadata associated with the device identifier comprises:
one or more device activity statuses corresponding to one or more respective reporting period for the respective device having the respective device identifier.

15. The system of claim 14, wherein generating the data item further comprises:
setting values of an activity history for the respective device to a default value, wherein the activity history includes an indication for each reporting period that an activity status was received from the respective device.

16. The system of claim 10, further comprising:
receiving a third set of surrogate identifiers from a third set of devices of the plurality of devices, wherein each surrogate identifier comprises metadata indicating an activity status of a respective device of the third set of devices for a third time-window;
determining, based on the third set of surrogate identifiers and at least one of: the first set of surrogate identifiers or the second set of surrogate identifiers, that the respective device of the third set of devices is included in the first set of devices and the second set of devices;
determining a third number of active devices for the third time-window from the third plurality of surrogate identifiers; and
determining, based on the first number and the third number, a second device lifecycle metric.

17. The system of claim 16, further comprising:
determining, based on the second device lifecycle metric and the first device lifecycle metric, a rolling average lifecycle metric.

18. The system of claim 10, wherein determining that the respective device of the second set of devices is included in the first set of devices comprises:
determining whether an observation window aggregation spanning the first time-window and the second time-window includes the respective device of the second set of devices.

19. A non-transitory computer-readable storage medium comprising instructions that, when executed by one or more processing devices, cause a server to perform operations comprising:
receiving a first set of surrogate identifiers from a first set of devices of a plurality of devices, wherein each surrogate identifier comprises an activity status of a respective device of the first set of devices for a first time-window;
determining a first number of active devices for the first time-window from the first set of surrogate identifiers;
receiving a second set of surrogate identifiers from a second set of devices of the plurality of devices, wherein each surrogate identifier comprises metadata indicating an activity status of a respective device of the second set of devices for a second time-window;
determining, based on the first set of surrogate identifiers and the second set of surrogate identifiers, that the respective device of the second set of devices is included in the first set of devices;
determining a second number of active devices for the second time-window from the second set of surrogate identifiers; and
determining, based on the first number and the second number, a device lifecycle metric characterizing the plurality of devices.

20. The non-transitory computer-readable storage medium of claim 19, the operations further comprising:
maintaining a data structure comprising a plurality of data items, wherein each data item comprises:
a device identifier, and
device metadata associated with the device identifier;
receiving an encrypted query from the respective device at the data structure, wherein the encrypted query inquires whether the data structure comprises a respective device identifier for the respective device; and
responsive to determining that the data structure comprises the respective device identifier, permitting the respective device to access respective device metadata associated with the respective device identifier.
